(19) United States
(12) Patent Application Publication
(10) Pub. No.: US 2015/0170040 A1
(43) Pub. Date: Jun. 18, 2015

(54) METHOD AND DEVICE FOR AUTOMATICALLY RECOMMENDING COMPLEX OBJECTS

(71) Applicant: WEPINGO, Paris (FR)

(72) Inventors: Uriel David BERDUGO, Massy (FR); Zied SELLAMI, Massy (FR); Nathalie SEYMAN, Alfortville (FR); Céline ALEC, Anthony (FR)

(21) Appl. No.: 14/574,959

(22) Filed: Dec. 18, 2014

(30) Foreign Application Priority Data
Dec. 18, 2013 (FR) 1362933

(51) Int. Cl. G06N 5/04; G06F 17/30

(52) U.S. Cl. CPC G06N 5/04; G06F 17/30707

(57) ABSTRACT

A method for automatic recommendation of complex objects of a predefined field to a user using a recommendation engine, the method including the following steps: the user expresses a need in the form of an input on an interface; the recommendation engine calculates a recommendation as a function of the need expressed by the user; a display displays the recommendation calculated by the recommendation engine; the recommendation engine using a normalized catalogue for the calculation of the recommendation.

### TECHNICAL FIELD OF THE INVENTION

The technical field of the invention is systems for recommendation of products to users and particularly to internauts. This invention relates to a method and a device for automatic recommendation of complex objects. For the purposes of this document, a “complex object” or “complex product” is an object or a product that has a text description, potentially rich with information but not formally defined and not normalised.

### TECHNOLOGICAL BACKGROUND OF THE INVENTION

There are different recommendation systems. A first type of recommendation systems relates to a shopping assistant that learns the preferences of a user. When a user asks a shopping assistant for the first time, he is given a questionnaire so as to determine the first orientation of his preferences. Subsequently, whenever the user chooses a product or indicates an appreciation of a product, the shopping assistant continues to learn the user's preferences. This is a kind of funnel system that uses learning by reinforcement techniques. This first type of recommendation systems does not make use of a text description of products.

A second type of recommendation systems relates to a social purchase platform operating as an aggregator of community shopping catalogues. This social purchasing platform emphasises social aspects rather than an understanding of a user preferences. Thus, no processing is done on descriptions and available information about products to determine user preferences.

A third type of recommendation systems relates to a shopping assistant for non-complex technical products that provides its users with a set of available filters so that said users can customise their needs. Said non-complex technical products are previously analysed and normalised manually. A “non-complex technical product” or “technical product” refers to a product with a normalised technical datasheet. For example it may be a camera, a telephone, a dishwasher, etc. For example, a technical datasheet for a camera usually contains information about the weight, the dimensions, the number of pixels and the size of the screen of said camera.

Therefore existing recommendation systems typically only use technical information as provided by manufacturers without performing any specific processing on this technical information. In general, all that is used to compare several offers is the price and the barcode. Some sale sites manually add additional information called “tags” to their products. However, at the present time there is no automated system for the recommendation of complex objects.

### SUMMARY OF THE INVENTION

The invention provides a solution to the problems mentioned above by disclosing a method of automatic recommendation of complex objects in order to automatically, precisely and quickly generate a personalised recommendation as a function of a need expressed by a user.

Therefore one aspect of the invention applies to a method for automatic recommendation of complex objects of a predefined field to a user using a recommendation engine, the method comprising:

a step according to which the user expresses a need in the form of an input on an interface;

a step according to which the recommendation engine calculates a recommendation as a function of the need expressed by the user;

a step according to which a display displays the recommendation calculated by the recommendation engine;

the recommendation engine using a normalised catalogue for the calculation of the recommendation, the normalised catalogue being obtained by:

a step to create an unprocessed catalogue of complex objects of a predefined domain, each complex object having a text description;

a step to identify and delete any duplicates among the complex objects of the unprocessed catalogue to obtain a refined catalogue;

a step to create a model, called a “catalogue ontology” of the predefined domain, the catalogue ontology comprising a hierarchy of first characteristics;

an annotation step in which a search is made for at least one manifestation of each first characteristic of the catalogue ontology in the text description of each complex object of the refined catalogue and each complex object of the refined catalogue is annotated with each first characteristic of the catalogue ontology of which at least one first manifestation was found in the text description of said complex object, to obtain a formally defined catalogue;

a step to create a model, called the “user ontology”, of selection criteria of a complex object of the predefined domain, the user ontology comprising a hierarchy of second characteristics;

a step to align the user ontology with the catalogue ontology, in which at least one first characteristic of the catalogue ontology is associated with each second characteristic of the user ontology, the first characteristic having a normalised value quantifying the degree of correspondence of said first characteristic with said second characteristic, to obtain the normalised catalogue.

The invention makes it possible to automatically, precisely and quickly generate a personal recommendation of a complex object of a predefined domain as a function of a need expressed by a user in said predefined domain of complex objects. To achieve this, the need expressed by the user is formatted by means of the user ontology. Therefore the need expressed by the user comprises one or several second characteristics of the user ontology. The recommendation engine uses the normalised catalogue to associate each second characteristic of the user ontology included in the need expressed by the user with one or several first characteristics of the catalogue ontology. The recommendation engine uses the normalised catalogue to assign a normalised value to each association or correspondence of a first characteristic of the catalogue ontology with a second characteristic of the user ontology in order to quantify the degree of correspondence of said first characteristic with said second characteristic. The recommendation engine then generates a personal recommendation comprising one or several complex objects, possibly hierarchised, of the normalised catalogue, as a function of the fine and weighted correspondences produced between the second characteristic(s) of the user ontology initially extracted from the need expressed by the user, and the first characteristic(s) of the catalogue ontology.

In the annotation step, “manifestation” refers to a term, a word or an expression. A manifestation of a first characteristic is thus a term, a word or an expression specific to said first characteristic.

In this description, a “complex object” means an object with a text description, potentially rich with information but not formally defined and not normalised. In opposition, for the purposes of this description, a “technical object” refers to an object with a formally defined technical datasheet.

The terms “a characteristic” and “a concept” of an ontology are used indifferently in this description.

Apart from the characteristics that have just been mentioned in the previous section, the method according to the invention may have one or several complementary characteristics among the following characteristics considered individually or in any technically possible combination:

The unprocessed catalogue of complex objects of the predefined domain is obtained by compiling a plurality of catalogues of complex objects of the predefined domain.

Each first characteristic of the catalogue ontology comprises a definition and one or several examples.

A set of simple linguistic signs is associated with each first characteristic of the catalogue ontology, each simple linguistic sign being a linguistic manifestation that can be used to denote or evoke said first characteristic. A linguistic manifestation denotes a term, a word or an expression.

A set of complex linguistic signs is associated with each first characteristic of the catalogue ontology, each complex linguistic sign contributing to differentiating several first characteristics of the catalogue ontology.

The step to annotate each complex object of the refined catalogue with at least one first characteristic of the catalogue ontology advantageously comprises the following sub-steps:

a first sub-step to annotate each complex object of the refined catalogue with one or several candidate annotations, as a function of correspondences detected between at least one text element of the text description of said complex object and one or several first characteristics of the catalogue ontology;

a second sub-step to detect inconsistencies in previously determined candidate annotations to only keep coherent annotations.

The second sub-step to detect inconsistencies advantageously uses a plurality of incompatibility rules, each incompatibility rule defining:

an incompatibility constraint between a first type of annotation and a second type of annotation,

and a priority, of the first type of annotation over the second type of annotation, or of the second type of annotation over the first type of annotation, so as to be able to choose the annotation to be kept and the annotation to be deleted if applicable.

The annotation step advantageously comprises a third completion sub-step to extend coherent annotations with affiliated annotations.

The third completion sub-step advantageously uses a plurality of implication rules, each implication rule being used to test the existence of a first type of annotation for a complex object and if applicable to annotate said complex object with a second type of annotation complementary to the first type of annotation.

The step to align the user ontology with the catalogue ontology is done manually.

The predefined domain is the domain of games and toys, and the complex objects are games or toys.

Another aspect of the invention relates to an automatic recommendation system for complex objects to a user comprising:

a first module for generation of an unprocessed catalogue of complex objects of the predefined domain, each complex object having a text description;

a second cleaning module accepting said unprocessed catalogue as input and returning a refined catalogue as output, the second module comprising means of identifying and eliminating any duplicates among the complex objects of the unprocessed catalogue;

a third module to generate a formal definition, called the “catalogue ontology”, of the predefined domain, the catalogue ontology comprising a hierarchy of first characteristics;

a fourth formalisation module accepting the refined catalogue and the catalogue ontology as input and returning a formally defined catalogue as output, the fourth module comprising means of annotating each complex object of the refined catalogue with at least one first characteristic of the catalogue ontology;

a fifth module to generate a formal definition, called a “user ontology”, of selection criteria for a complex object of the predefined domain, the user ontology comprising a hierarchy of second characteristics;

a sixth normalisation module accepting the formally defined catalogue and the user ontology as input and returning a normalised catalogue as output, the sixth module comprising means of associating at least one first characteristic of the catalogue ontology with a normalised value quantifying the degree of correspondence of said first characteristic with said second characteristic, with each second characteristic of the user ontology;

a recommendation engine accepting the normalised catalogue and an expression of the need of the user in the predefined domain of complex objects as input, said expression comprising at least one second characteristic of the hierarchy of second characteristics of the user ontology and returning as output a recommendation as a function of said expression and of the normalised catalogue;

an interface by which the user inputs the expression of his need in the predefined domain of complex objects;

a display that displays the recommendation returned by the recommendation engine.

The third and fifth modules advantageously use an ontology editor. The fifth module is identical to the third module in one particular embodiment of the invention.

Another aspect of the invention relates to a computer program that, when it is loaded on a computer, comprises means of implementing the steps in the automatic method of recommending complex objects according to one aspect of the invention.

The invention and its different applications will be better understood after reading the following description and examining the accompanying figures.

### BRIEF DESCRIPTION OF THE FIGURES

The figures are presented for information and are in no way limitative of the invention.

FIG. 1a shows a diagrammatic representation of a system for automatic recommendation of complex objects of a predefined domain to a user according to one embodiment of the invention.

FIG. 1b shows a diagrammatic representation of the organisation for the steps of a method of automatic recommendation of complex objects of a predefined domain to a user according to one embodiment of the invention.

FIGS. 2a to 2d show different steps of the method of FIG. 1b.

FIG. 3a diagrammatically shows a first ontology of the domain of vehicles.

FIG. 3b diagrammatically shows an example alignment between the first ontology of FIG. 3a, and a second ontology.

FIG. 4 shows an example of a first concept of a catalogue ontology comprising a definition, first and second examples, and first, second, third and fourth complex signs.

FIG. 5 shows an example application of three phases of an annotation step.

FIG. 6 shows an example of a vector representation of four complex objects.

### DETAILED DESCRIPTION OF AT LEAST ONE EMBODIMENT OF THE INVENTION

Unless specified otherwise, a single element that appears on different figures will always have the same reference.

FIG. 1a shows a diagrammatic representation of a system S for automatic recommendation of complex objects of a predefined domain to a user U according to one embodiment of the invention. FIG. 1b shows a diagrammatic representation of the organisation of steps in a method 100 of automatic recommendation of complex objects of a predefined domain to the user U according to one embodiment of the invention. Figures 1a and 1b are described jointly. For the purposes of this description, “a complex object” is an object with a text description, potentially rich with information but not formally defined and not normalised. On the other hand, for the purposes of this description, a “technical object” is an object with a formal technical datasheet. The user U expresses a need in the form of an input on an interface Int, in a step 101 of the method 100. The expression of the need of the user U is sent to a recommendation engine MR. According to one step 102 in the method 100, the recommendation engine MR calculates a recommendation, as a function of the need expressed by the user U and using a normalised catalogue C_Nrm. The recommendation calculated by the recommendation engine MR is sent to a display unit D and the display unit D displays said recommendation in a step 103 of the method 100. The user U can then receive first information about the recommendation calculated automatically by the recommendation engine MR in response to the need initially expressed by the user. The normalised catalogue C_Nrm is advantageously obtained by means of steps 201 to 206 that will now be described. In step 201, a first module mod1 generates an unprocessed catalogue C_b of complex objects of the predefined domain, each complex object having a text description. The first module mod1 is for example a compilation module of a plurality of complex object catalogues of the predefined domain. In step 202, a second module mod2 is used to generate a refined catalogue C_n. The second module mod2 is a cleaning module that accepts the unprocessed catalogue C_b as input and returns the refined catalogue C_n as output. In step 203, a third module mod3 is used to generate a catalogue ontology Onto_C. In step 204, a fourth module mod4 is used to generate a formally defined catalogue C_Frm. The fourth module mod4 is a formalisation module that accepts the refined catalogue C_n and the catalogue ontology Onto_C as input and returns a formally defined catalogue C_Frm as output. In step 205, a fifth module mod5 generates a user ontology Onto_U. In the particular embodiment disclosed herein, the fifth module mod5 is identical to the third module mod3. In step 206, a sixth module mod6 is used to generate the normalised catalogue C_Nrm. The sixth module mod6 is a normalisation module that accepts the formally defined catalogue C_Frm and the user ontology Onto_U as input and returns the normalised catalogue C_Nrm as output.

FIG. 2a contains a detailed description of the step 201 used to obtain the normalised catalogue C_Nrm according to one embodiment of the invention. In step 201, an unprocessed catalogue C_b of complex objects of the predefined domain is created, each complex object having a text description. To achieve this, different catalogues of complex objects of a predefined domain may be compiled, for example originating from different manufacturers or shopping sites. For the purposes of this description, the chosen domain (also called the “world” or “universe”) is games and toys. Other domains of complex objects are possible, for example travel, gifts, sport activities, artistic and cultural activities, etc. The different catalogues can all have the same format or they may have different formats. The xml, csv or txt formats are examples of possible formats. The barcode of each product may or may not be filled in, in the different catalogues.

A first catalogue C1 and a second catalogue C2 are thus compiled in the example shown in FIG. 2a. The first catalogue C1 references a first complex object obj1 and a second complex object obj2, while the second catalogue C2 references a third complex object obj3 and a fourth complex object obj4. A single unprocessed catalogue C_b is obtained at the end of step 201, containing all complex objects from the different initial catalogues, in other words the first, second, third and fourth complex objects obj1 to obj4 in the first and second catalogues C1 and C2.

FIG. 2b gives a detailed illustration of step 202 in which the normalised catalogue C_Nrm is obtained according to one embodiment of the invention. In step 202, a plurality of so-called “cleaning rules” R_n is used to identify and delete any duplicates among the complex objects of the unprocessed catalogue C_b to obtain a refined catalogue C_n without any redundancy. A single object may have different names in different catalogues. For example, a name “Ladybird chilled tooth rattle” and the name “Ladybird dentition rattle” denote the same product. If a duplicate is identified between a first complex object and a second complex object, the duplicate is advantageously eliminated by merging the first and second complex objects, and particularly by merging the descriptions of the first and second complex objects. In this way, each object of the refined catalogue C_n is described by a set of descriptors derived from the text description(s) associated with this object, that are compiled in the unprocessed catalogue C_b.

The cleaning rules R_n are based particularly on one of the following two techniques in order to detect similar products:

a first technique to compare barcodes and particularly EAN (European Article Numbering) barcodes for products. The EAN code is a global system used for unambiguous identification of objects. However, this first technique is not sufficient, firstly because some catalogues assign internal barcodes to their products and secondly because some products do not have a barcode;

a second technique for the comparison of product names or labels, in other words a technique for comparison of character strings that uses automatic language processing (ALP) methods.

One possible implementation of the second technique for comparison of product labels will now be disclosed. With this implementation, product labels are firstly extracted from the refined catalogue C_n by the application of regular expressions. A regular expression is a model or pattern created using ASCII characters and used to manipulate a character string, in other words to find the portion(s) of said string corresponding to the model. For example, to identify the size of clothes, for example XS, S, M, L, XL or XXL in a clothes type object label, we can define the following regular expression, in this case written in the Java Regex language:

\b(XS|S|M|L|XXL|XL)\b

Once extracted, some words and/or characters are cleaned from product labels. A list of words and characters to be deleted from labels of products may for example include:

the words “of”, “with”, “without” . . .

the characters “−”, “+”, “[”, “]” etc.

Finally, a word processing technique called stemming is applied to each cleaned product label in order to obtain a reduced version of said cleaned label. The stemming algorithm described in the “An algorithm for suffix stripping”, Martin F. Porter, Program: Electronic Library & Information Systems, 40(3):211-218, 1980 document could be used. Reduced versions are then compared.

In the example shown in FIG. 2b, the second and third complex objects obj2 and obj3 are thus similar. The cleaning rules R_n are used to detect this similarity and to only keep one of the two objects. In this case, the second object obj2 is kept and the third object obj3 is deleted from the refined catalogue C_n. After the second step 102, the result obtained is the refined catalogue C_n that contains non-redundant complex products.

According to step 203 in which the normalised catalogue C_Nrm is obtained according to one embodiment of the invention, a so-called “catalogue ontology” formalisation Onto_C is made of the predefined domain. In this document, “an ontology of a domain” refers to formal definition of knowledge related to this domain. Therefore, an ontology of a domain defines a vocabulary that is used to describe the data for this domain. In this case, the catalogue ontology Onto_C formally defines semantic characteristics to be identified in text descriptions of complex objects of the refined catalogue C_n.

An ontology includes different entities:

concepts;

properties;

instances;

and possibly axioms.

A concept, also called a “class”, is an abstraction of a set of objects belonging to a domain. For example, an “engine” concept and a “car” concept can form part of an ontology describing the automobile domain or the transport domain. Concepts of an ontology are organised using hierarchical relations called subsumption relations. In addition to hierarchical relations, the concepts of an ontology may be related by non-hierarchical relations called properties between concepts. Instances are both instances of concepts and instances of properties, for example the expression “the neighbour's red car” is an instance of the “car” concept while the triplet “the neighbour's red car”, “owns”, “4-cylinder diesel engine” is an instance of the “owns” property. Finally, axioms are used to express constraints between instances of concepts that cannot be modelled through hierarchical and non-hierarchical relations. For example, an axiom can be used to state that an instance of a “person” concept cannot be associated with it by a non-hierarchical “be married to” relation. It should be noted that several ontologies may be produced for a single domain. One preferred embodiment of the catalogue ontology Onto_C for the special case of the games and toys domain will be described later. FIG. 3a illustrates an example of a first ontology O1 for the vehicles domain, to facilitate understanding. The first ontology O1 includes:

a first concept O1_C1 of an object;

a second concept O1_C2 of a car;

a third concept O1_C3 of a locomotive;

a fourth concept O1_C4 of an engine;

a fifth concept O1_C5 of horse power.

A car is an object and therefore the second “car” concept O1_C2 is related to the first “object” concept O1_C1 by a first property P1. A locomotive is an object and therefore the third “locomotive” concept O1_C3 is also related to the first “object” concept O1_C1 by the first property P1. A car has an engine and therefore the second “car” concept O1_C2 is related to the fourth “engine” concept O1_C4 by a second property P2. An engine has a given horse power and therefore the fourth “engine” concept O1_C4 is also related to the fifth “horse power” concept O1_C5 by the second property P2. Finally, a locomotive also has a given horse power, and therefore the third “locomotive” concept O1_C3 is related to the fifth “horse power” concept O1_C5 by the second property P2.

FIG. 2c shows a detailed illustration of the step 204 in which the normalised catalogue C_Nrm is obtained according to one embodiment of the invention. According to step 204, the refined catalogue C_n is formally defined in order to obtain a formally defined catalogue C_Frm. Step 204 is based on the catalogue ontology Onto_C produced in step 203. During step 204, each first concept of the catalogue ontology Onto _C is searched for in the text description of each complex object of the refined catalogue C_n. Each complex object of the refined catalogue C_n is then annotated with at least one first concept of the catalogue ontology Onto_C, to obtain the formally defined catalogue C_Frm.

As mentioned previously, the catalogue ontology Onto_C formally defines the semantic characteristics that are to be identified in the text descriptions of complex objects of the refined catalogue C_n. Each object of the refined catalogue C_n is annotated with one or several concepts of the catalogue ontology Onto_C, in other words, each concept of the catalogue ontology Onto_C is searched for in all descriptors of each complex object of the refined catalogue C_n. When a concept of the catalogue ontology Onto_C is detected among the set of descriptors of a complex object of the refined catalogue C_n, said complex object is annotated with said concept. This annotation step is automated making use of automatic language processing (ALP) and text classification techniques. A preferred embodiment of this annotation step will be described in detail later. Finally, the annotation step is used to associate one or several concepts of the catalogue ontology Onto_C with each complex object of the refined catalogue C_n to obtain a formally defined catalogue C_Frm.

According to step 205for obtaining the normalised catalogue C_Nrm according to one embodiment of the invention, a formal definition Onto_U called the “user ontology” is made of the selection criteria for a complex object of the predefined domain. The user ontology Onto_U formally defines criteria that a user can use to choose a complex object of the predefined domain.

FIG. 2d contains a detailed illustration of the step 206 in which the normalised catalogue C_Nrm is obtained according to one embodiment of the invention. According to step 206, the formally defined catalogue C_Frm is normalised in order to obtain a normalised catalogue C_Nrm. The formally defined catalogue C_Frm is normalised based on alignment of ontologies. Alignment of a first ontology with a second ontology consists of setting up alignment relations between the concepts of the first ontology and the concepts of the second ontology and assigning normalised values, in other words values between 0 and 1, to the alignment relations produced. During alignment of a first ontology with a second ontology, an attempt is thus made to create correspondences or matches, also called “mapping”, between the concepts and properties of the first and the second ontologies.

The User ontology Onto_U in this case is aligned with the catalogue ontology Onto_C. Each concept of the user ontology Onto_U is aligned with a given normalised value, with one or several concepts of the catalogue ontology Onto_C. The normalised catalogue C_Nrm thus comprises a plurality of complex objects, each complex object being annotated with one or several concepts of the catalogue ontology Onto_C, and each concept of the catalogue ontology Onto_C being aligned with one or several concepts of the user ontology Onto_U, with a certain normalised value.

The creation of alignment relations between the concepts of the user ontology Onto_U and the concepts of the catalogue ontology Onto_C may be determined using semi-automatic tools, for example like those described in the following references:

“TaxoMap in the OAEI 2009 alignment contest”, Faycal Hamdi et al., The Fourth International Workshop on Ontology Matching (2009);

“Prompt: Algorithm and tool for automated ontology merging and alignment”, Natalya Fridman et al., Proceedings of the Seventeenth National Conference on Artificial Intelligence and Twelfth Conference on Innovative Applications of Artificial Intelligence p. 450-455 (2000);

“Optima: Tool for ontology alignment with application to semantic reconciliation of sensor metadata for publication in sensormap”, Ravikanth Kolliet al., IEEE International Conference on Semantic Computing p. 484-485 (2008).

However, alignment relations or alignment rules are preferably created manually. The quality of alignment relations is particularly important to achieve optimum efficiency of the formalisation and normalisation method 100 of an unprocessed catalogue of complex objects according to the invention. One or several experts in the domain considered are thus advantageously called in when alignment relations are set up, in order to contribute to their fineness and their relevance. The next step is to assign a normalised value to each previously determined alignment relation. Normalised values are assigned manually, preferably by one or several experts in the domain considered, in this case the domain of games and toys. Thus, a contribution is made to obtaining a weighted and fine alignment between the catalogue ontology Onto_C and the user ontology Onto_U.

Since the alignment step is only done once, the potentially long time that it requires is acceptable: a final user is not penalised by the potential duration of the alignment step. The main difficulty encountered during alignment of two ontologies is related to the fact that two ontologies do not model exactly the same domain, and therefore do not use the same vocabulary. Thus, the same expression may have a first semantic sense for a first ontology, and a second semantic sense for a second ontology, different from the first semantic sense. In this case, the catalogue ontology Onto_C formally defines concepts related to the games and toys domain, whereas the user ontology Onto_U formally defines selection criteria for a toy or a game by a user. If alignment relations are set up automatically, the alignment relations are typically classical relations of the following type:

equivalence, for example: a first concept of the first ontology is equivalent to a second concept of the second ontology;

subsumption, for example: the first concept of the first ontology is a son of the second concept of the second ontology.

If alignment relations are set up manually, then apart from the conventional relations mentioned above, alignment relations include fine relations such as “evocation” type relations, for example the first concept of the first ontology evokes the second concept of the second ontology.

A normalised value is assigned to each alignment relation manually, advantageously by one or several experts in the field, independently of the manner in which alignment relations are set up (automatically or manually).

FIG. 3b diagrammatically shows an example alignment between the first ontology O1 described in FIG. 3a, and a second ontology O2, to facilitate understanding. The second ontology O2 includes:

a first concept O2_C1 of an object;

a second concept O2_C2 of a vehicle;

a third concept O2_C3 of a train;

a fourth concept O2_C4 of an automobile;

a fifth concept O2_C5 of engine power.

A vehicle is an object and therefore the second “vehicle” concept O2_C2 is related to the first “object” concept O2_C1 by the first property P1, already defined with relation to FIG. 3a. A train is a vehicle and therefore the third “train” concept O2_C3 is related to the second “vehicle” concept O2_C2 by the first property P1. An automobile is also a vehicle, therefore the fourth “automobile” concept O2_C4 is also related to the second “vehicle” concept O2_C2 by the first property P1. A train and an automobile each have a given engine power, therefore the third and fourth “train” concept O2_C3 and “automobile” concept O2_C4 are related to the fifth “engine power” concept O2_C5 by the second property P2, previously defined with reference to FIG. 3a.

One possible alignment between the first ontology O1 and the second ontology O2 is as follows:

set up a first alignment relation between the first “object” concept O1_{—O}1 of the first ontology O1 and the first “object” concept O2_C1 of the second ontology O2, with a normalised value V1=1;

set up a second alignment relation between the third “locomotive” concept O1_C3 of the first ontology O1 and the third “train” concept O2_C3 of the second ontology O2, with a normalised value V2=0.7;

set up a third alignment relation between the fifth “horse power” concept O1_C5 of the first ontology O1 and the fifth “horse power” concept O2_C5 of the second ontology O2, with a normalised value V3=1;

set up a fourth alignment relation between the second “car” concept O1_C2 of the first ontology O1 and the fourth “automobile” concept O2_C4 of the second ontology O2, with a normalised value V4 =0.9.

It should be noted that the two ontologies may be aligned in several different manners, by means of several distinct alignments that differ in their alignment relations and/or their normalised values.

We will now give a second example alignment, this time between the user ontology Onto_U and the catalogue ontology Onto_C. This second example alignment is defined in the XML (Extensible MarkupLanguage) language:

```
<concept ID=″Creativity″>
  <map>
    <target>Scenario_game</target>
    <value>0.5</value>
  </map>
  <map>
    <target>Graphic_production_game</target>
    <value>0.8</value>
  </map>
  <map>
    <target>Construction_game</target>
    <value>0.7</value>
  </map>
</concept>
```

This second example alignment shows how a “Creativity” concept of the user ontology Onto_U, that formally defines selection criteria for a game or a toy is aligned with some concepts of the catalogue ontology Onto_C, that formally defines the domain of games and toys. The “Creativity” concept of the user ontology Onto_U is thus aligned with:

a “Scenario_{—} game” concept of the catalogue ontology Onto C, with a normalised value of 0.5;

a “Graphic_production_game” concept of the catalogue ontology Onto_C, with a normalised value 0.8;

a “Construction_game” concept of the catalogue ontology Onto_C, with a normalised value of 0.7.

This alignment means that three concepts of the catalogue ontology Onto_C, namely the “Scenario_game”, “Graphic_production_game” and “Construction_game” concepts evoke a creativity concept and therefore evoke the “Creativity” concept of the user ontology Onto_U. The normalised values mean that a graphic production game develops creativity more than a construction game or a scenario game. We now mention that after the end of the third step 103, previously described with reference to FIG. 2d, the formally defined catalogue C_Frm is obtained in which each complex object is annotated with one or several concepts of the catalogue ontology Onto_C. After the fourth step 104 that has just been described, each concept of the user ontology Onto_U has been aligned with a given normalised value, with one or several concepts of the catalogue ontology Onto_C.

In the case in which several normalised values have been assigned to a complex object for a single concept of the user ontology Onto_U, the selected normalised value is the maximum value. For example, a complex object that has been annotated with the “Scenario_game” and “Construction_game” concepts of the catalogue ontology Onto_C will have the normalised value equal to 0.7 for the “Creativity” concept of the user ontology Onto_U. According to one embodiment of the step to align the catalogue ontology Onto_C with the user ontology Onto_U in the special case in which the catalogue ontology Onto_C and the user ontology Onto_U relate to the complex object domain of games and toys, 17 alignment rules in the XML language have been set up between the concepts of the catalogue ontology Onto_U and the concepts of the user ontology Onto U.

The above description has disclosed a preferred case of an embodiment of the alignment step according to which the user ontology Onto_U is aligned with the catalogue ontology Onto_C, and according to which each concept of the user ontology Onto_U is aligned with a given normalised value, with one or several concepts of the catalogue ontology Onto_C. The result is thus to guarantee that each concept of the user ontology Onto_U is effectively aligned, in other words it is put into correspondence with at least one concept of the catalogue ontology Onto_C. This preferred embodiment that makes use of the user ontology Onto_U as a reference and reviews all concepts of the user ontology Onto_U, advantageously optimises operation of the recommendation engine MR. The recommendation engine MR uses one or several second concepts of the user ontology Onto_U, that are extracted from the need expressed by the user, and each second concept is put into correspondence with one or several first concepts of the catalogue ontology Onto_C. However, the inverse approach may alternately be adopted, according to which the catalogue ontology Onto_C is aligned with the user ontology Onto_U, each concept of the catalogue ontology Onto_C being aligned with one or several concepts of the user ontology Onto_U, with a certain normalised value.

After having disclosed details of the different steps to obtain the normalised catalogue C_Nrm used by the recommendation engine MR of the method 100 for automatic recommendation of complex objects according to one embodiment of the invention, we will now consider:

a preferred embodiment of the refined catalogue C_n;

a preferred embodiment of the catalogue ontology Onto_C;

a preferred embodiment of the step to annotate each complex object of the refined catalogue C_n with one or several concepts of the catalogue ontology Onto_C;

a preferred embodiment of the user ontology Onto_U.

According to one preferred embodiment, the refined catalogue C_n is produced based on a module for identification of similar products within the unprocessed catalogue C_b. The module for identification of similar products is based on:

a comparison of EAN barcodes of products, when said barcodes are available;

a comparison of character strings (names) in product labels.

This latter type of comparison is based on a plurality of cleaning rules R_n making use of regular expressions written in Java Regex. In the previously described special example embodiment dealing with the domain of games and toys, 54 regular expressions are thus defined in order to clean labels of different products listed in the unprocessed catalogue C_b so that a refined catalogue C_n can be built up. Defined regular expressions can be used particularly to delete the following information from product labels:

colours: “blue”, “black”, “black and white”, . . .

age information: “5 years”, “5-8 years”, “above 10 years”, etc.

sizes: “M”, “size XL”, etc.

dimensions: “42×12 cm”, 42×12×13 mm”, etc.

information considered to be useless: “2012 promotion”, “web exclusive”, “exclusive pack”, etc.

technical information: “1.4 Mp”, “32 Ghz”, etc.

For example, the character string “size M (12/14 years)” can be identified from the expression “(?i) (|̂|,|:)+( )*size (xs|l|m|s|xl)*( )*(\\( )*[0-9]+([−|/|]+[0-9]+)*(month|year)+(\\))*(|$)+” in a product label.

According to one preferred embodiment, the refined catalogue C_n is constructed using the following protocol:

Obtain the unprocessed catalogue C_b of complex objects. The unprocessed catalogue C_b may for example be in the csv format. Each complex object available on said unprocessed catalogue C_b is also called “offer”.

Delete information considered as being useless in each offer. An offer for which “useless” information has been deleted is called a “declination”.

Delete technical information, dimensions, sizes, age information, colours from each declination. A declination from which . technical information, dimensions, sizes, age indications and colours have been eliminated is called an “elementary product”.

To identify similar declinations or similar elementary products:

“Empty” characters such as numbers, parentheses, symbols such as “+”, “−”, “\” . . . are eliminated from labels of said declinations and said elementary products.

The labels thus obtained are truncated using the stemming technique mentioned above.

The character strings of truncated labels obtained after stemming are then compared.

One preferred embodiment of the catalogue ontology Onto_C is now described for the special case of the domain of games and toys. According to this preferred embodiment, the catalogue ontology Onto_C is based on work done in the ESAR (Exercise, Symbolic, Assembly and Rule) system. The ESAR system is described particularly in the following references:

“The language and affectivity through the analysis of game objects: complementary facets of the ESAR system”, Rolande Fillon et al., Documentator (1993);

“The ESAR system: analysis, classification and organisation guide for a collection of toys and games”, Denise Garonet al., Editions ASTED (2002).

The ESAR system is in the form of a classification organised in facets dealing with the intellectual, motor, social, language and affective development. The ESAR system that is internationally recognised, used and validated provides a means of obtaining a tool for classification and psychological analysis of games, toys and game objects. Therefore, it is quite suitable for use in the special case of the domain of games and toys.

In the preferred embodiment described herein, the catalogue ontology Onto_C is written in the OWL language. The OWL language is a knowledge representation language, used particularly for applications related to the semantic web. The OWL language thus provides mechanisms to create components of an ontology, in other words concepts, properties, concept instances and property instances, axioms. For example, “VW 1.4 TSI motor” is an instance of a “motor” concept. According to the preferred embodiment disclosed herein, an ontology editor and particularly the “Protected” ontology editor, is used to construct the catalogue ontology Onto_C.

Therefore, a catalogue ontology Onto_C related to the domain of toys is created, that classifies toy categories and toy characteristics. Therefore in this case, the concepts of the catalogue ontology Onto_C can be categories or characteristics. Toy categories refer to toy types; for example a construction game, a game of chance, a strategy game etc. Toy characteristics refer to:

educational values transmitted by a toy, for example concentration, dexterity, cognitive or functional skills;

and/or conditions of use of a toy or a game, for example team game, associative game, individual game or competitive game, etc.

33 toy categories and 129 toy characteristics are considered in the example described herein. Each toy category is associated with one or several toy characteristics. The following table describes an example concept of the catalogue ontology Onto_C, obtained from the ESAR system according to the preferred embodiment:

| Concept: | Puzzle game |
|---|---|
| Definition: | Intellectual game during which a problem |
| | or a riddle has to be solved or a |
| | situation described in obscure mysterious |
| | terms has to be guessed. |
| Examples: | Coded messages game, detective game, game |
| | with clues leading to a riddle (Clue, |
| | Cluedo, Mystery of the Abbey). |

Each concept thus includes a definition and one or several examples. Advantageously, examples associated with each concept of the catalogue ontology Onto_C are completed by using external resources. A larger number of examples can thus be obtained for each concept.

Advantageously, each concept is associated with a set of terms or more generally a set of linguistic symbols frequently used to denote it or evoke it. This is done by creating a property called “linguistic signs”, by which a plurality of linguistic signs are defined for each concept. For example, the linguistic signs “Clue” and “Riddle” are associated with the “Puzzle game”.

Advantageously, a plurality of complex linguistic signs is also defined for each concept by means of a “complex linguistic signs” property. A “complex linguistic sign” is an expression applicable to examples related by logical operators, for example of the type “and” and “not”, and contributes to making a distinction between concepts and products, and clearing ambiguities. It is possible that an example considered in isolation is not sufficient to make a distinction between two product categories. For example the term “domino” extracted from a definition of a toy and considered alone, may be associated with a concept of “association game” or a concept of “construction game”. There are actually two types of dominos: dominos numbered from 1 to 6 that players attempt to associate (association game), and dominos without distinctive signs; with which one or several players build up a pathway and then drop one domino at a first end that makes the following dominos drop—construction game. Therefore a complex linguistic sign is a condition on a combination of several keywords, for example with “first keyword AND second keyword”, or “first keyword AND second keyword AND NOT third keyword”, etc. Thus, to make an annotation, it is not sufficient to find the presence of a single keyword, the presence and/or absence of other keywords also have to be checked. For the case of dominos, the following linguistic signs can thus be built up:

“domino AND construction” to make the annotation with the “construction game” concept;

“domino AND NOT construction” to make the annotation with the “association game” concept.

FIG. 4 shows an example of a first concept 1 “Construction game” of the catalogue ontology Onto_C displayed in the “Protected” ontology editor, the first concept 1 comprising

a definition D;

a first example ex1 “the Meccano case” and a second example ex2 “parts to be put together”;

a first complex sign Sc1 “dominos AND construction”, a second complex sign Sc2 “domino AND marbles”, a third complex sign Sc3 “domino AND construction” and a fourth complex sign Sc4 “dominos AND marbles”.

We will now describe a preferred embodiment of the annotation step of each complex object of the refined catalogue C_n with one or several concepts of the catalogue ontology Onto_C. In the preferred embodiment, the annotation step comprises three phases:

a first phase in which each complex object of the refined catalogue C_n is annotated with one or several candidate annotations as a function of correspondences or “matching”, detected between said complex object and one or several concepts of the catalogue ontology Onto_C;

a second phase in which any inconsistencies in the previously produced candidate annotations are detected so as to keep only coherent annotations;

a third phase in which the coherent annotations may be completed with affiliated annotations.

During the first phase, the candidate annotations are identified by relating and comparing:

firstly, concepts or labels, linguistic signs and/or complex linguistic signs, and examples of the catalogue ontology Onto_C;

secondly, text contents or text descriptions of complex objects of the refined catalogue C_n.

Therefore the first phase or the matching phase consists of finding the labels, examples and linguistic signs that may or may not be complex in the set of available information about a complex object, in this case a game or a toy. If the name, category or description of a complex object comprises a label, an example or a linguistic sign of a concept, then said complex object is annotated by said concept. For example, it is considered that the refined catalogue C_n comprises a complex object for which the description includes the expression “Modelling clay” that is an “example” of a “3D production game” concept of the catalogue ontology Onto_C. The complex object is then annotated with the “3D production game” concept.

During the second phase, any inconsistencies in the candidate annotations produced during the first phase are detected using a set of rules in order to verify incompatibility constraints between annotations and if applicable to make a choice about which annotations should be kept and which should be deleted. For example, a complex object is considered for which information includes the words “ball” and “figurine”. The word “ball” is related to a “sports game” concept of the catalogue ontology Onto_C, and the word “figurine” is related to a “scenario game” concept of the catalogue ontology Onto_C. Therefore, after the first phase, said complex object is annotated with the “sports game” and “scenario game” concepts. However in this case, the word “ball” introduces some confusion: it is not a real ball, instead it is a miniature ball associated with a figurine. The rules for detection of inconsistencies, also called incompatibility rules applied during the second phase, are used to determine that the “sports game” and “scenario game” concepts are disjoint, and also to indicate that the “scenario game” concept prevails over “sports game” concept. Therefore, incompatibility rules express a choice between annotations considered to be incompatible. Incompatibility rules are often in the format “IF concept A AND concept B THEN NOT concept A”. In the particular example disclosed herein, 30 incompatibility rules written in the XML language have been defined for concepts of the catalogue ontology Onto_C. An example incompatibility rule is thus: “IF Sports_game AND Scenario_game THEN NOT Sports_game”. Erroneous annotations are eliminated at the end of the second phase.

The third annotation completion phase identifies complementary annotations of annotations that were kept after the second phase. This third phase can advantageously optimise the recall, in other words the number of relevantly annotated complex objects to the total number of complex objects to be annotated. This can be done using a set of implication rules of the “IF concept A THEN concept B” type implication. In the special example described herein, an implication rule may for example be “IF Sports_game THEN Motor_game”. Thus, if a complex object was annotated with the concept “Sports game” during the second phase, the “Motor game” concept will also be associated with it during the third phase. Inferences are advantageously made from implication rules. Thus, if a first implication rule “IF concept A THEN concept B” is defined and a second implication rule “IF concept B THEN concept C” is defined, a complex object annotated by concept A during the second phase will be annotated by B during the third phase, and then annotated by C by inference. 95 completion rules written in the XML language were defined in the special example disclosed herein.

FIG. 5 shows an example application of the three phases of the annotation step that have just been described. FIG. 5 shows a set 10 of information about a complex object of the refined catalogue C_n. The first matching phase in information set 10:

detects a first term t1 and annotates the first term t1 with an annotation t1_A of the “Scenario_{—} game” concept of the catalogue ontology Onto_C;

detects a second term t2 and annotates the second term t2 with an annotation t2_A of the “Motor_game” concept of the catalogue ontology Onto_C;

detects a third term t3 “Figurines” and annotates the third term t3 with a plurality t3_A of annotations of the “Expressive_creativity”, “Scenario_game”, “Reproduction_of_roles” and “Reproduction_of_events” concepts of the catalogue ontology Onto_C.

At the end of the first matching phase, the complex object considered is annotated with a plurality of candidate annotations A_ph1, comprising:

a first candidate annotation A1 “Scenario_game”;

a second candidate annotation A2 “Motor_game”;

a third candidate annotation A3 “Expressive_creativity”;

a fourth candidate annotation A4 “Reproduction_of_roles”;

a fifth candidate annotation A5 “Reproduction_of_events”.

The plurality of candidate annotations A_ph1 is the redundancy-free compilation of annotations t1_A, t2_A and t3_A associated with the first, second and third terms t1, t2 and t3. The plurality of candidate annotations A_ph1 might be considered as an interpretation context of the complex object considered.

A plurality of incompatibility rules R_inc are applied during the second phase to detect inconsistencies, which has the effect in this particular example of eliminating the second candidate annotation A2. At the end of the second phase, the complex object is then annotated with a plurality of coherent annotations A_ph2, comprising the first candidate annotation A1 and the third, fourth and fifth candidate annotations A3, A4 and A5.

A plurality of completion rules, also called implication rules R_imp, are then applied during the third annotation completion phase, which in this particular example has the effect of adding the following annotations:

a sixth annotation A6 “Inventive creativity”;

a seventh annotation A7 “Delayed_imitation”.

At the end of the third phase, the complex object is finally annotated with a plurality of coherent and complete annotations A_ph3 comprising the first candidate annotation A1, the third, fourth and fifth candidate annotations A3, A4 and A5, and the sixth and seventh completion annotations A6 and A7.

In addition to the annotation step of each complex object of the refined catalogue C_n with one or several concepts of the catalogue ontology Onto_C for which a preferred embodiment has just been disclosed, it is advantageously possible to make one or several complementary annotation steps of complex objects of the refined catalogue C_n. According to a first complementary annotation step, a plurality of categories of complex objects of the refined catalogue C_n are established. Each category, also called “ping”, is associated with one or several concepts of the catalogue ontology Onto_C. The next step is a classification of complex objects of the refined catalogue C_n in the previously determined categories. When a complex object is classified in a category, it is annotated with the concepts associated with said category.

According to a second complementary annotation step, a classifier is advantageously used to contribute to improving the annotation ratio of complex objects of the refined catalogue C_n with concepts of the catalogue ontology Onto_C. A classifier is a statistical data classification technique, used particularly in the domain of automatic learning. In the case described herein, the role of the classifier is thus to classify complex objects of the refined catalogue C_n with similar properties, into different classes. The classifier does this by learning from text type elements or “attributes” available for each complex object: label, mark, category, description, etc.

For example, an SVM (Support Vector Machine) classifier can be used as described in the following documents:

“Support-vector networks”, Corinna Cortes at al., Mach. Learn., 20(3): 273-297 (1995);

“Text categorization with support vector machines: Learning with many relevant features”, Thorsten Joachims, Proceedings of the 10th European Conference on Machine Learning, p. 137-142 (1998).

In particular, a classifier such as “LIBLINEAR” that is a linear SVM type classifier, described particularly in the document “LIBLINEAR: A library for large linear classification”, Rong-En Fan et al., Journal of Machine Learning Research, 9 :1871-1874 (2008), can be used particularly.

In order to implement the second complementary annotation step, the first step is to make a vector representation of each complex object of the refined catalogue C_n. Several vector representations of the “bag of words” type have been tested for this purpose. A “bag of words” type vector representation uses a dictionary of words of a certain size. Each complex object is represented by a vector with the same size as the dictionary of words, each element in the vector representing one word in the dictionary of words.

A first tested vector representation of the “bag of words” type is a binary representation in which each element of the vector is equal to “1” if the word corresponding to said element in the vector is present among the attributes of the complex object considered, or is equal to “0” if the word corresponding to said element in the vector is missing in the attributes of the complex object considered. A second tested vector representation of the “bag of words” type is a Term Frequency-Inverse Document Frequency (TF-IDF) representation to evaluate the importance of a word contained in a document within a corpus of documents; in other words in this case, the importance of an attribute of a complex object within a catalogue of complex objects. The importance or the weight of a word varies in proportion to the frequency of the word in the document. The weight of a word also varies and is inversely proportional to the frequency of the word in the corpus of documents, the idea being that as a word becomes rarer in the corpus, then its presence in a document has more weight. The first and second tested vector representations are described particularly in the document “Introduction to Modern Information Retrieval”, Gerard Salton et al. (1983).

Equations typically used to weight words in a TF-IDF vector representation are given below:

$$∀ word ∈ dictionary , ∀ document ∈ corpus , \\ TDIDF ( word , document ) = TF ( word , document ) \times IDF ( word )$$

$$where TF ( word , document ) = \frac{number of occurences of the word in the document}{number of words in the document}$$

$$and IDF ( word ) = \frac{number of documents in the corpus}{number of documents containing the word in the corpus}$$

The dictionary used is composed of words output from attributes of complex objects. The attributes of a complex object may for example be a label or a name, a mark, a category or a description as mentioned above. A priori, it is not known whether or not all attributes are equally important, or if some attributes are more important than others. Therefore, different sets of attributes are advantageously tested for the first and second vector representations considered, and particularly:

a first set of attributes denoted LM comprises the label and mark for each complex object;

a second set of attributes denoted LMC comprises the label, mark and category for each complex object;

a third set of attributes denoted LMCD comprises the label, mark, category and description for each complex object.

In order to improve operation of the classifier, a basic list also called a “stop-list” of words that are to be ignored will advantageously be defined. This basic list includes for example items such as numbers, pronouns, prepositions, determinants, abbreviations and conjunctions. A generated list that can be configured by a user can also advantageously be proposed in order to complete the basic list if required, by defining other types of words that should be ignored.

FIG. 6 shows an example of a vector representation of four complex objects. FIG. 6 thus shows a vector representation RV1 of a first complex object, a vector representation RV2 of a second complex object, a vector representation RV3 of a third complex object and a vector representation RV4 of a fourth complex object. The four vector representations RV1 to RV4 of the first, second, third and fourth complex objects in the particular example in FIG. 6 constitute a class learning sample. In this case, the first three characters in each vector representation indicate whether or not the complex object considered belongs to said class: “1.0” indicates that the complex object belongs to the class, and “0.0” indicates that the complex object does not belong to the class. The next characters provide information about the weight TF-IDF of each word in the dictionary actually present in the set of attributes for the complex object considered. For example, the character string “20:0.053068508132264526” in the vector representation RV1 of the first complex object indicates that the word rank 20 in the dictionary is present in all attributes for the first complex object with a weight TF-IDF equal to 0.053068508132264526.

According to the classifier approach, the annotation of a complex object of the refined catalogue C_n with one or several concepts of the catalogue ontology Onto_C consists of associating a binary value with each concept of the catalogue ontology Onto_C, for the complex object considered. When the binary value “1” is assigned to a concept of the catalogue ontology Onto_C, the complex object is annotated with said concept. When the binary value “0” is assigned to a concept of the catalogue ontology Onto_C, the complex object is not annotated with said concept. In the example disclosed more particularly in this description in which the complex objects are games or toys, the established catalogue ontology Onto_C comprises 162 concepts, one concept possibly corresponding equally well to a category or a characteristic. If the 162 concepts of the catalogue ontology Onto_C are to be discriminated with a single classifier, said classifier has to be capable of modelling 2¹⁶² classes of toys, which is about 6×10⁴⁸ different classes, starting from learning examples. In the embodiment described herein, it is preferred to use one classifier per concept of the catalogue ontology Onto_C, namely 162 classifiers in this particular example in which the catalogue ontology Onto_C comprises 162 concepts. Each classifier thus models 2¹ classes.

Therefore in the above we have disclosed a preferred embodiment of the annotation step, comprising the first phase in which candidate annotations are set up, the second phase in which any inconsistencies in the candidate annotations are detected so as to keep only coherent annotations, and the third phase for completion of any annotations coherent with affiliated annotations. The annotation step can then advantageously be completed by the first complementary annotation step that uses complex object categories and/or the second complementary annotation step that uses a classifier. The annotation step and the first complementary annotation step correspond to a linguistic approach, while the second complementary annotation step corresponds to a statistical approach.

We will now evaluate the annotation results obtained using the linguistic approach. The first step in testing the annotation method using the linguistic approach is to construct a sample of complex objects in a random manner starting from a plurality of catalogues. For example, the sample may comprise a hundred complex objects. The complex objects in the example described herein are toys. The next step is a manual step to make a reference annotation for each complex object in the sample. The annotation method using the linguistic approach is then applied to each complex object in the sample, so as to automatically obtain automatic annotations. Automatic annotations are then compared with the reference annotations. This can be done by evaluating several parameters including:

the precision that is defined in this disclosure as being the ratio of the number of relevantly annotated complex objects to the total number of annotated complex objects;

the recall that is defined in this disclosure as being the ratio of the number of relevantly annotated complex objects to the total number of toys that should have been annotated;

a general performance indicator “F_measure”, defined in this disclosure by the relation

$$F\_measure = \frac{2 \times precision \times recall}{precision + recall}$$

The following table presents the results obtained for the automatic annotations as a function firstly of the three previously defined parameters and for different degrees of perfection of the catalogue ontology Onto_C, and secondly the annotation method using the linguistic approach:

| | | Case 1 | Case 2 | Case 3 | Case 4 |
|---|---|---|---|---|---|
| Catalogue | Examples and | No | Yes | Yes | Yes |
| ontology | linguistic | | | | |
| Onto_C | signs | | | | |
| | Complex | No | No | Yes | Yes |
| | linguistic | | | | |
| | signs | | | | |
| Annotation | Detection of | No | No | No | Yes |
| method | inconsistencies | | | | |
| using the | and completion | | | | |
| linguistic | of candidate | | | | |
| approach | annotations | | | | |
| Evaluation | Precision (%) | 38 | 87 | 88 | 94 |
| of | Recall (%) | 20 | 55 | 59 | 64 |
| automatic | F_measure (%) | 26 | 68 | 71 | 76 |
| annotations | | | | | |

In case 1, the catalogue ontology Onto_C was not enriched with examples or linguistic signs, nor with complex linguistic signs. Therefore the catalogue ontology Onto_C does not contain much information. Furthermore, in case 1, the annotation method does not comprise any phases for detection of any inconsistencies among the candidate annotations, nor completion with candidate annotations. The quality of automatic annotations is mediocre, with 38% precision, 20% recall and 26% de F_measure. Case 2 provides a significant improvement in automatic annotations (87% precision, 55% recall, 68% F_measure) due to the introduction of new examples and linguistic signs in the catalogue ontology Onto_C, that were not present in case 1. Case 3 includes the addition of complex linguistic signs in the catalogue ontology Onto_C, that were not present in case 2. The quality of automatic annotations is even more improved. Finally, case 4 is different from case 3 in that inconsistency detection and candidate annotation completion phases are included in the annotation method using the linguistic approach. The results obtained in the latter case, in other words 94% precision, 64% recall and 76% F_measure, are quite interesting and satisfactory. However, a manual validation of automatic annotations obtained by the annotation method described herein is advantageously made using the linguistic approach.

We will now test the annotation method using the statistical approach.

One possible test protocol is as follows:

a first representative sample of the catalogue C_n is determined within the refined catalogue C_n. The first sample comprises a plurality of first complex objects;

the plurality of first complex objects in the first sample is annotated manually;

the first sample, for which each first complex object has been manually annotated, is used to create a classification model;

the classification model is used as a learning base for the classifier of the annotation method using the statistical approach;

a second sample distinct from the first sample is used within the refined catalogue C_n. The second sample comprises a plurality of second complex objects and does not include any first complex object in the plurality of first complex objects in the first sample;

the classifier of the annotation method using the statistical approach is used to annotate the second sample;

the relevance of automatic annotations made by the classifier on the plurality of second complex objects in the second sample is evaluated.

In order to create the classification model, the type of vector representation and the set of attributes that will give the most relevant results with the classifier are determined. The different types of vector representation are for example the binary or TF-IDF type representations described previously. The different sets of attributes are for example the first, second and third sets of attributes described previously, comprising the label and mark (LM), the label, mark and category (LMC) or the label, mark, category and description (LMCD) for each complex object.

One preferred embodiment of the user ontology Onto_U will now be described. According to the preferred embodiment, the user ontology Onto_U is modelled in the OWL language, using the “Protected” ontology editor. The user ontology Onto_U may advantageously comprise conceptual criteria, for example criteria identified with an expert in the field of complex objects considered, and technical criteria. In the special case of the domain of games and toys, 17 conceptual criteria are thus determined with an expert for the user ontology Onto_U, including autonomy, imagination, creativity, confidence, improvement, etc. In this case, each conceptual criterion thus refers to a type of development that a game or a toy might provide. Five technical criteria have been defined for the user ontology Onto_U, for the same special case of the domain of games and toys:

a recommended age, for example a minimum age and a maximum age;

an environment, for example an indoor game, an outdoor game or a water game;

the sex, for example a boy's game, a girl's game or a game for both;

a trademark, for example Barbie or Spiderman (registered trademarks);

the origin of the toy, for example France, Germany or the United States.

Having described and illustrated the principles of the invention with reference to various embodiments, it will be recognized that the various embodiments can be modified in arrangement and detail without departing from such principles. It should be understood that the programs, processes, or methods described herein are not related or limited to any particular type of computing environment, unless indicated otherwise. Various types of specialized computing environments may be used to perform operations in accordance with the teachings described herein. Elements of embodiments shown in software may be implemented in hardware and vice versa.

One or more devices, processors or processing devices may be configured to execute one or more sequences of one or more machine executable instructions contained in a main memory to implement the method described herein. Execution of the sequences of instructions contained in a main memory causes the processor to perform at least some of the process steps described herein. One or more processors in a multi-processing arrangement may also be employed to execute the sequences of instructions contained in a main memory. In alternative embodiments, hard-wired circuitry may be used in place of or in combination with software instructions. Thus, embodiments are not limited to any specific combination of hardware circuitry and software.

Various forms of computer readable media may be involved in carrying one or more sequences of one or more instructions to processor for execution. The term “computer-readable medium” as used herein refers to any medium that participates in providing instructions to a processor for execution. Such a medium may take many forms, including but not limited to, non-volatile media, volatile media and transmission media. Non-volatile media include, for example, optical or magnetic disks. Volatile media include, for example, dynamic memory. Transmission media include, for example, coaxial cables, copper wire and fiber optics. Common forms of computer-readable media include, for example, a floppy disk, a flexible disk, a hard disk, a magnetic tape or any other magnetic medium, a CD-ROM, a DVD or any other optical medium, a punch card, a paper tape or any other physical medium with patterns of holes, a RAM, a PROM, an EPROM, a FLASH-EPROM or any other memory chip or cartridge, a carrier wave, and any other medium from which a computer can read.

The computer program comprising machine executable instructions for implementing the method can be implemented by a computer comprising at least an interface, a physical processor and a non-transitory memory, also broadly referred to as a non-transitory machine readable or storage medium. The computer is a special purpose computer as it is programmed to perform the specific steps of the methods described above. The non-transitory memory is encoded or programmed with specific code instructions for carrying out the above methods and its associated steps. The non-transitory memory is arranged in communication with the physical processor so that the physical processor, in use, reads and executes the specific code instructions embedded in the non-transitory memory. The interface of the special purpose computer is arranged in communication with the physical processor and receives input parameters that are processed by the physical processor.

For example, the different modules shown in FIG. 1a may include one or more processors, which can be shared in an embodiment, and one more storage media, which can be shared in an embodiment.

It will be appreciated by one skilled in the art that the method of FIG. 1b and other methods described herein represent a solution to the technological problem described above.

1. A method for automatic recommendation of complex objects of a predefined field to a user using a recommendation engine, the method comprising:
a step according to which the user expresses a need in the form of an input on an interface;
a step according to which the recommendation engine calculates a recommendation as a function of the need expressed by the user;
a step according to which a display displays the recommendation calculated by the recommendation engine;
the recommendation engine using a normalised catalogue for the calculation of the recommendation, the normalised catalogue being obtained by:
a step to create an unprocessed catalogue of complex objects of a predefined domain, each complex object having a text description;
a step to identify and delete any duplicates among the complex objects of the unprocessed catalogue to obtain a refined catalogue;
a step to create a model, called that defines a catalogue ontology, of the predefined domain, the catalogue ontology comprising a hierarchy of first characteristics;
an annotation step in which a search is made for at least one manifestation of each first characteristic of the catalogue ontology in the text description of each complex object of the refined catalogue and each complex object of the refined catalogue is annotated with each first characteristic of the catalogue ontology of which at least one first manifestation was found in the text description of said complex object, to obtain a formally defined catalogue;
a step to create a model that defines a user ontology, of selection criteria of a complex object of the predefined domain, the user ontology comprising a hierarchy of second characteristics;
a step to align the user ontology with the catalogue ontology, in which at least one first characteristic of the catalogue ontology is associated with each second characteristic of the user ontology , the first characteristic having a normalised value quantifying the degree of correspondence of said first characteristic with said second characteristic, to obtain the normalised catalogue.

2. The method according to claim 1, wherein the unprocessed catalogue of complex objects of the predefined domain is obtained by compiling a plurality of catalogues of complex objects of the predefined domain.

3. The method according to claim 1, wherein each first characteristic of the catalogue ontology comprises a definition and one or several examples.

4. The method according to claim 3, wherein a set of simple linguistic signs is associated with each first characteristic of the catalogue ontology, each simple linguistic sign being a linguistic manifestation that is usable to denote or evoke said first characteristic.

5. The method according to claim 3, wherein a set of complex linguistic signs is associated with each first characteristic of the catalogue ontology, each complex linguistic sign contributing to differentiating several first characteristics of the catalogue ontology.

6. The method according to claim 1, wherein the annotation step to annotate each complex object of the refined catalogue with at least one first characteristic of the catalogue ontology comprises the following sub-steps:
a first sub-step to annotate each complex object of the refined catalogue with one or several candidate annotations, as a function of correspondences detected between at least one text element of the text description of said complex object and one or several first characteristics of the catalogue ontology;
a second sub-step to detect inconsistencies in previously determined candidate annotations to only keep coherent annotations.

7. The method according to claim 6, wherein the second sub-step to detect inconsistencies uses a plurality of incompatibility rules, each incompatibility rule defining:
an incompatibility constraint between a first type of annotation and a second type of annotation,
and a priority, of the first type of annotation over the second type of annotation, or of the second type of annotation over the first type of annotation, so as to be able to choose the annotation to be kept and the annotation to be deleted if applicable.

8. The method according to claim 6, wherein the annotation step comprises a third completion sub-step to extend coherent annotations with affiliated annotations.

9. The method according to claim 8, wherein the third completion sub-step uses a plurality of implication rules, each implication rule being used to test the existence of a first type of annotation for a complex object and if applicable to annotate said complex object with a second type of annotation complementary to the first type of annotation.

10. The method according to claim 1, wherein the step to align the user ontology with the catalogue ontology is done manually.

11. The method according to claim 1, wherein the predefined domain is the domain of games and toys, and the complex objects are games or toys.

12. An automatic recommendation system for complex objects to a user, comprising:
a first module for generation of an unprocessed catalogue of complex objects of the predefined domain, each complex object having a text description;
a second cleaning module, accepting said unprocessed catalogue as input and returning a refined catalogue as output, the second module comprising means of identifying and eliminating any duplicates among the complex objects of the unprocessed catalogue;
a third module to generate a formal definition, that defines a catalogue ontology, of the predefined domain the catalogue ontology comprising a hierarchy of first characteristics;
a fourth formalisation module, accepting the refined catalogue and the catalogue ontology as input and returning a formally defined catalogue as output, the fourth module comprising means of annotating each complex object of the refined catalogue with at least one first characteristic of the catalogue ontology;
a fifth module to generate a formal definition that defines a user ontology, of selection criteria for a complex object of the predefined domain, the user ontology comprising a hierarchy of second characteristics;
a sixth normalisation module accepting the formally defined catalogue and the user ontology as input and returning a normalised catalogue as output, the sixth module comprising means of associating at least one first characteristic of the catalogue ontology with a normalised value quantifying the degree of correspondence of said first characteristic with said second characteristic, with each second characteristic of the user ontology;
a recommendation engine accepting the normalised catalogue and an expression of the need of the user in the predefined domain of complex objects as input, said expression comprising at least one second characteristic of the hierarchy of second characteristics of the user ontology, and returning as output a recommendation as a function of said expression and of the normalised catalogue;
an interface by which the user inputs the expression of his need in the predefined domain of complex objects;
a display that displays the recommendation returned by the recommendation engine.

13. A machine readable medium including a computer program that comprises machine executable instructions for implementing the steps in the automatic method according to claim 1.
